(19) United States
(12) Patent Application Publication
(10) Pub. No.: US 2023/0103686 A1
(43) Pub. Date: Apr. 6, 2023

(54) Frame Component for a Front End Module

(71) Applicant: Bayerische Motoren Werke Aktiengesellschaft, Muenchen (DE)

(72) Inventors: Oeztzan AKIF, Muenchen (DE); Timo HAUSNER, Muenchen (DE); Arne KOEHLER, Pliening (DE); Haci Korkusuz JANKET, Putzbrunn (DE)

(21) Appl. No.: 17/913,526

(22) PCT Filed: May 12, 2021
(86) PCT No.: PCT/EP2021/062645

§ 371 Date: Sep. 22, 2022

(30) Foreign Application Priority Data
May 15, 2020 (DE) 10 2020 113 206.9

(51) Int. Cl. B62D 21/15

(52) U.S. Cl. CPC B62D 21/152

(57) ABSTRACT

A frame component for a front end module of a vehicle is provided. The frame component has a blocking element mounted thereto which serves load transfer to a crossmember of the vehicle in the event of a crash.

### BACKGROUND AND SUMMARY

The present invention relates to a frame component for a front end module of a vehicle, to a front end module having the frame component, and to a vehicle having the front end module.

In modern vehicles, especially passenger cars, various driving assistance systems are installed in the front region. In the event of a crash or a collision at low speed, such as, for example, a test speed in US Part 581 of approximately 2.41 km/h, it is necessary to ensure that these driving assistance systems are not damaged and are restored to their original or initial position, so that they are still functional even after the crash.

The ability of the vehicle to compensate for such effects at low speeds is tested as part of a homologation, for example as part of a test according to US Part 581, by means of a pendulum impact test, in which an impactor acts on the front region of the vehicle.

In order to minimize intrusion of the impactor or to increase the ability to protect the driving assistance system in the front region, installation spaces of the vehicle are conventionally filled with comparatively very rigid components, i.e. additional components are provided for reinforcement in the front region of the vehicle.

By providing these additional rigid components, which can also be referred to as impact absorbers, a force of the acting impactor is introduced, in particular directly, into a crash management system of the vehicle, and the intrusion is thus minimized. The crash management system is usually formed substantially by a crossmember in the front region of the vehicle.

Damage to the vehicle in the event of a collision at low speeds, for example during parking or unparking, can thus be reduced.

These rigid components can be, for example, additionally provided rigid foam blocks, which are integrated into a pedestrian protection foam, and/or can be produced from an extruded aluminum profile, which is fastened to a vehicle beam.

The disadvantage of providing the additional rigid components is that they are conventionally embodied as separate components which must be installed or mounted, in particular at the factory, in an additional assembly step during the production of the vehicle.

It is therefore the object of the invention, inter alia, to overcome this disadvantage from the prior art.

According to the invention, this object is achieved by the features of the independent claims. Advantageous embodiments are specified in the dependent claims.

The object is accordingly achieved by a frame component for a front end module of a vehicle. The frame component has a blocking element attached thereto for load transfer to a crossmember of the vehicle in the event of a crash.

That is to say that the blocking element, which, in the event of a crash, transfers a load to the crossmember or into a crash management system of the vehicle and minimizes intrusion or penetration of foreign bodies, such as, for example, the impactor during the pendulum impact, is integrated into the frame component itself

At least one blocking element is attached or fixed to the frame component. However, it is contemplated for a plurality of blocking elements to be attached to the frame component in a manner distributed over the transverse direction of the vehicle.

The blocking element can be arranged on the inside of the frame component, i.e. between the frame component and the crossmember, in the longitudinal direction of the vehicle.

The frame component can also accommodate an ornamental grille and have corresponding apertures for a sensor, such as a LIDAR (light detection and ranging) sensor, of the vehicle.

The frame component may also be referred to as a multifunctional frame. The frame component can be a frame for an air flap control system of the vehicle. The frame component can then receive air flaps if this is necessary due to the type of drive device of the vehicle, for example in the case of an internal combustion engine. It is also contemplated for the frame component not to receive any air flaps if this is not necessary owing to the nature of the drive device, for example in the case of an electric motor.

As a result of the integration of the blocking element, the frame component becomes the force-carrying system between the impactor and the crossmember, thus reducing the intrusion of foreign bodies in the case of parking bumps described at the outset and preventing damage to driving assistance systems installed in the front region of the vehicle.

By providing the blocking element as an integral part of the frame component, the latter no longer has to be mounted on the crossmember as a separate component during the production of the vehicle, in particular at the factory of the vehicle manufacturer, but can be delivered premounted on the frame component and can be installed together with the frame component in one assembly step.

The blocking element may also be referred to as a block element or impact absorber. In comparison with the rest of the frame component, the blocking element has a higher rigidity and strength.

The frame component and the blocking element can be of one-piece design. In the present case, one-piece means that the frame component and the blocking element consist of one piece or part. In particular, the frame component and the blocking element can be embodied as an injection molding.

The blocking element can be attached as a separate component to the frame component, in particular by means of a welded joint, a clip joint and/or an adhesive joint.

Furthermore, a front end module of a vehicle is provided. The front end module has the above-described frame component and a crossmember. The blocking element attached to the frame component is designed to transfer a load to the crossmember in the event of a crash.

The above description of the frame component also applies analogously to the front end module and vice versa.

The front end module may also be referred to as the front region or front end structure of a vehicle. In the present case, the front end module is a region of the vehicle which is arranged in front of an A-pillar of the vehicle in the longitudinal direction of the vehicle.

In the front end module, a shock absorber can be arranged on the crossmember. The shock absorber can be arranged between the crossmember and the blocking element in the longitudinal direction X of the vehicle.

The shock absorber is designed to absorb the energy of the blocking element attached to the frame component in the event of a crash by means of elastic and/or plastic deformation and to transfer it to the crossmember.

In the front end module, at least part of a driving assistance system can be arranged between the crossmember and the frame component in the longitudinal direction of the vehicle.

The driving assistance system can be, for example, a camera, a sensor, in particular a radar sensor and/or a LIDAR sensor, for a driving assistance system or a sensor, in particular an ultrasonic sensor, of a parking assistant.

Furthermore, a vehicle having the front end module is provided. The vehicle may be a passenger vehicle.

The above description of the frame component and the front end module also applies analogously to the vehicle and vice versa.

An embodiment is described below with reference to FIGS. 1 to 3.

### BRIEF DESCRIPTION OF THE DRAWINGS

FIG. 1 is a schematic sketch of a conventional frame component.

FIG. 2 is a schematic sketch of a frame component according to the embodiment.

FIG. 3 is a perspective view of the frame component from FIG. 2.

### DETAILED DESCRIPTION OF THE DRAWINGS

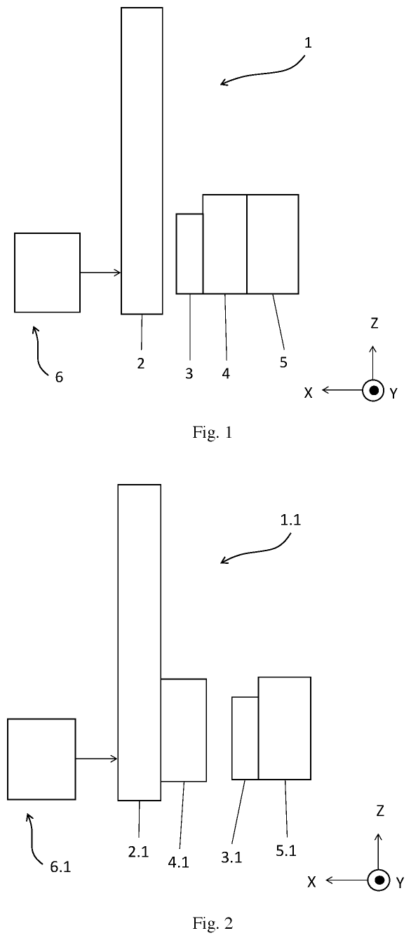

A front end module 1 of a vehicle having a conventional frame component 2 is illustrated in FIG. 1.

Furthermore, FIG. 1 shows a Cartesian coordinate system, where X is the longitudinal direction of the vehicle, Y is the transverse direction of the vehicle and Z is the vertical direction of the vehicle.

The front end module 1 has a crossmember 5. A blocking element 4 is attached or fastened to the crossmember 5 between the crossmember 5 and the frame component 2 in the longitudinal direction X of the vehicle.

A shock absorber 3 is attached or fastened to the blocking element 4 between the blocking element 4 and the frame component 2 in the longitudinal direction X of the vehicle.

In this case, the blocking element 4 is designed to limit intrusion, that is to say penetration of an impactor 6, illustrated here as a rigid obstacle 6, in the longitudinal direction X of the vehicle.

However, as described at the outset, the disadvantage of this conventional structure is that the blocking element 4 is embodied as a separate component which must be installed, in particular at the factory, in an additional assembly step during the production of the vehicle.

In the present invention, therefore, the blocking element 4 is not fastened to the crossmember 5, as can be seen from FIG. 2.

A front end module 1.1 of a vehicle having a frame component 2.1 according to the present invention is illustrated in FIG. 2.

Furthermore, FIG. 2, like FIG. 1, shows a Cartesian coordinate system, where X is the longitudinal direction of the vehicle, Y is the transverse direction of the vehicle and Z is the vertical direction of the vehicle.

The front end module 1.1 according to the invention has a crossmember 5.1. A shock absorber 3.1 is attached or fastened to the crossmember 5.1 between a blocking element 4.1 and the frame component 2.1 in the longitudinal direction X of the vehicle.

In contrast to the conventional construction, which has been described above with reference to FIG. 1, the blocking element 4.1 is attached to the frame component 2.1 or integrated therein.

In the front end module 1.1, at least part of a driving assistance system (not illustrated) is arranged between the crossmember 5.1 and the frame component 2.1 in the longitudinal direction X of the vehicle.

If, as illustrated by the arrow in FIG. 2, the obstacle 6.1 now strikes the frame component 2.1 or if the vehicle drives against the obstacle 6.1, and its intrusion, i.e. its penetration depth in the longitudinal direction X of the vehicle, is not minimized, the driving assistance system is damaged.

The ability of the vehicle to compensate for such effects at low speeds is also tested as part of a homologation, for example as part of a test according to US Part 581, by means of a pendulum impact test in which an impactor acts on the front region of the vehicle, i.e. in this case the frame component 2.1.

In order to meet these requirements, the blocking element 4.1 is provided. In this case, the blocking element 4.1 is designed to limit the intrusion, that is to say the penetration of the obstacle 6.1 in the longitudinal direction X of the vehicle.

The blocking element 4.1 is therefore provided for load transfer to the crossmember 5.1 of the vehicle in the event of a crash.

By providing the blocking element 4.1 as an integral part of the frame component 2.1, however, the blocking element no longer has to be mounted on the crossmember 5.1 as a separate component during the production of the vehicle, in particular at the factory of the vehicle manufacturer, but can be delivered premounted on the frame component 2.1 and can be installed together with the frame component 2.1 in one assembly step.

In this case, the frame component 2.1 and the blocking element 4.1 can be made in one piece, in particular as a single injection molding, or the blocking element 4.1 can be attached as a separate component to the frame component 2.1, in particular by means of a welded joint, a clip joint and/or an adhesive joint.

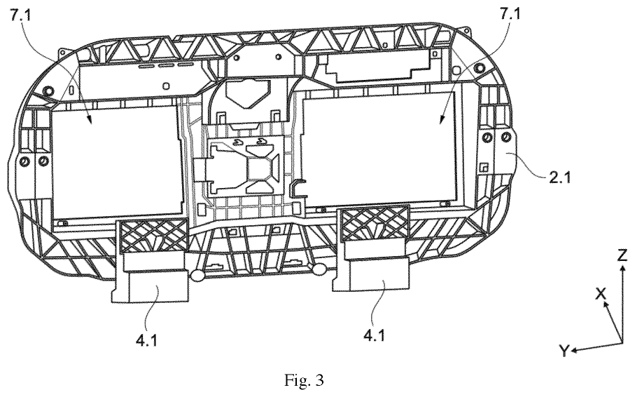

As can be seen from FIG. 3, which shows a perspective view of the frame component 2.1 according to the invention from FIG. 2, the number of blocking elements 4.1 is not limited to one.

FIG. 3, like FIGS. 1 and 2, shows a Cartesian coordinate system, where X is the longitudinal direction of the vehicle, Y is the transverse direction of the vehicle and Z is the vertical direction of the vehicle.

Rather, a plurality of blocking elements 4.1, in the present case two, can be arranged on the frame component 2.1 in a manner distributed over the transverse direction Y of the vehicle. It is also contemplated that additionally or alternatively a blocking element 4.1 is arranged in a central region of the frame component 2.1, i.e. in a region arranged centrally on the frame component 2.1 in the transverse direction Y of the vehicle and/or the vertical direction Z of the vehicle.

As can also be seen from FIG. 3, the frame component 2.1 has two apertures or holes 7.1 in order in this way to accommodate one or more air flaps or a grille, depending on whether or not a flow of cooling air has to be directed into an engine compartment of the vehicle. This means that the frame component 2.1 can be installed independently of a type of drive of the vehicle, for example both on vehicles with an internal combustion engine and with an electric motor.

In the present case, the blocking elements 4.1 are each arranged below the apertures 7.1 in the vertical direction Z of the vehicle.

### LIST OF REFERENCE SIGNS

1 front end module
2 frame component for the front end module
3 shock absorber
4 blocking element
5 crossmember
6 obstacle
1.1 front end module
2.1 frame component for the front end module
3.1 shock absorber
4.1 blocking element
5.1 crossmember
6.1 obstacle
7.1 aperture for air flaps or panel
X longitudinal direction of the vehicle
Y transverse direction of the vehicle
Z vertical direction of the vehicle

1.-8. (canceled)

9. A component for a front end module of a vehicle having a crossmember, comprising:
a frame component; and
a blocking element attached to the frame component for load transfer to the crossmember of the vehicle in an event of a crash.

10. The component according to claim 9, wherein
the frame component and the blocking element are of one-piece design.

11. The component according to claim 10, wherein
the frame component and the blocking element are embodied as an injection molding.

12. The component according to claim 9, wherein
the blocking element is attached as a separate component to the frame component.

13. The component according to claim 12, wherein
the attachment is at least one of: a welded joint, a clip joint, or an adhesive joint.

14. A front end module of a vehicle, comprising:
a crossmember; and
a frame component according to claim 9, wherein
the blocking element attached to the frame component is designed to transfer a load to the crossmember in the event of a crash.

15. The front end module according to claim 14, further comprising:
a shock absorber arranged on the crossmember, wherein
the shock absorber is arranged between the crossmember and the blocking element in a longitudinal direction of the vehicle.

16. The front end module according to claim 15, further comprising:
at least part of a driving assistance system arranged between the crossmember and the frame component for an air flap control system in the longitudinal direction of the vehicle.

17. The front end module according to claim 14, further comprising:
at least part of a driving assistance system arranged between the crossmember and the frame component for an air flap control system in the longitudinal direction of the vehicle.

18. A vehicle comprising a front end module according to claim 14.
